(19) United States
(12) Patent Application Publication
(10) Pub. No.: US 2002/0184799 A1
(43) Pub. Date: Dec. 12, 2002

(54) Garment hanger having a solid indicator attachment

(76) Inventor: Yi Li Chou, Chong Ho City (TW)

Correspondence Address: Yi Li Chou, P.O. Box 10-69, Chong Ho, Taipei, 235, TW

(21) Appl. No.: 09/877,528

(22) Filed: Jun. 7, 2001

(51) Int. Cl. G09F 3/00

(52) U.S. Cl. 40/322

(57) ABSTRACT

A garment hanger includes a flap extended upward from a hanger hook, and having one or more latches disposed in the middle portion, and having two or more side orifices. An indicator housing includes a chamber for receiving the flap and includes one or more middle apertures for receiving the latches and for securing the indicator housing onto the flap. The front wall of the indicator housing includes two sides each having one or more bulges for solidly engaging into the orifices of the flap and for preventing the indicator housing from becoming loose relative to the flap.

### BACKGROUND OF THE INVENTION

1. Field of the Invention

The present invention relates to a hanger device, and more particularly to a garment hanger having a solid indicator attachment.

2. Description of the Prior Art

U.S. Pat. No. 5,794,363 to Marshall et al. discloses a typical garment hanger including an indicator for attaching onto the hanger hook. The indicator is secured onto the hanger hook with a latch device or a lock device that is provided in the middle portion of the indicator and the hanger hook, such that the indicator may be rotated or moved relative to the hanger hook about the latch device, and such that the indicator may be easily become loose relative to the hanger hook.

The present invention has arisen to mitigate and/or obviate the afore-described disadvantages of the conventional garment hangers.

### SUMMARY OF THE INVENTION

The primary objective of the present invention is to provide a garment hanger having a solid indicator attachment.

In accordance with one aspect of the invention, there is provided a garment hanger comprising a hanger body including a hanger hook provided thereon, the hanger hook including a flap provided thereon, the flap including a middle portion having at least one latch provided therein and including two sides each having at least one orifice formed therein, and an indicator housing including a chamber formed therein and defined by a front wall and a rear wall, for receiving the flap, the indicator housing including a middle portion having at least one aperture formed therein for receiving the latch and for securing the indicator housing onto the flap, the front wall of the indicator housing including two sides each having at least one bulge extended inward of the chamber thereof for engaging into the orifices of the flap and for solidly securing the indicator housing onto the flap.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a partial perspective view of a garment hanger in accordance with the present invention;

FIG. 2 is an exploded view of the garment hanger;

FIG. 3 is a partial cross sectional view taken along lines 3-3 of FIG. 1;

FIG. 4 is a cross sectional view taken along lines 4-4 of FIG. 5; and

FIGS. 5 and 6 are cross sectional views taken along lines 5-5 and 6-6 of FIG. 4 respectively.

### DETAILED DESCRIPTION OF THE PREFERRED EMBODIMENT

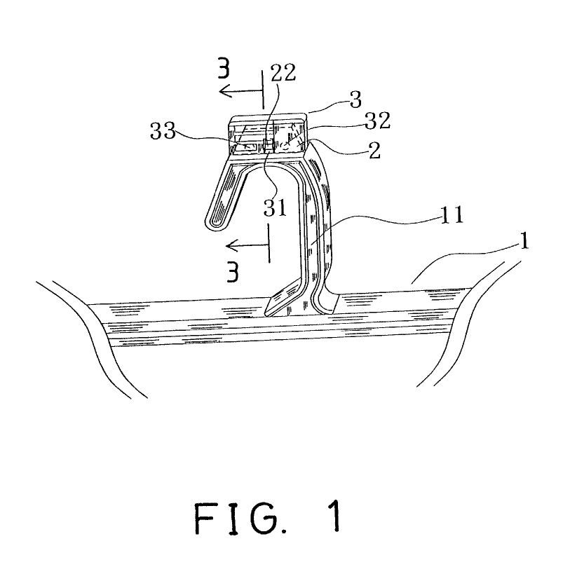

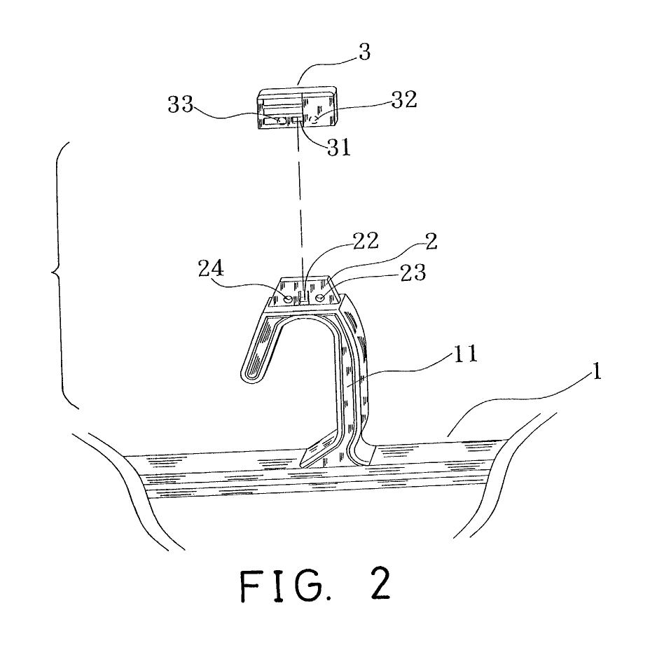

Referring to the drawings, and initially to FIGS. 1-3, a garment hanger in accordance with the present invention comprises a hanger body I including a hanger hook 11 provided thereon, and including a flap 2 extended or provided on top of the hanger hook 11. The flap 2 includes one or more, such as a pair of opposite, spring latches 22 disposed or provided on the middle portion thereof, and includes two or more orifices 23, 24 formed therein, particularly formed on the opposite sides of the spring latch 22 and spaced away from each other.

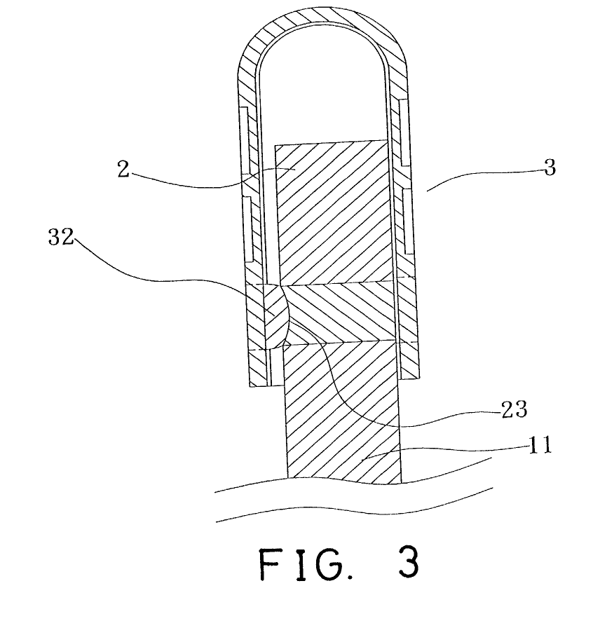

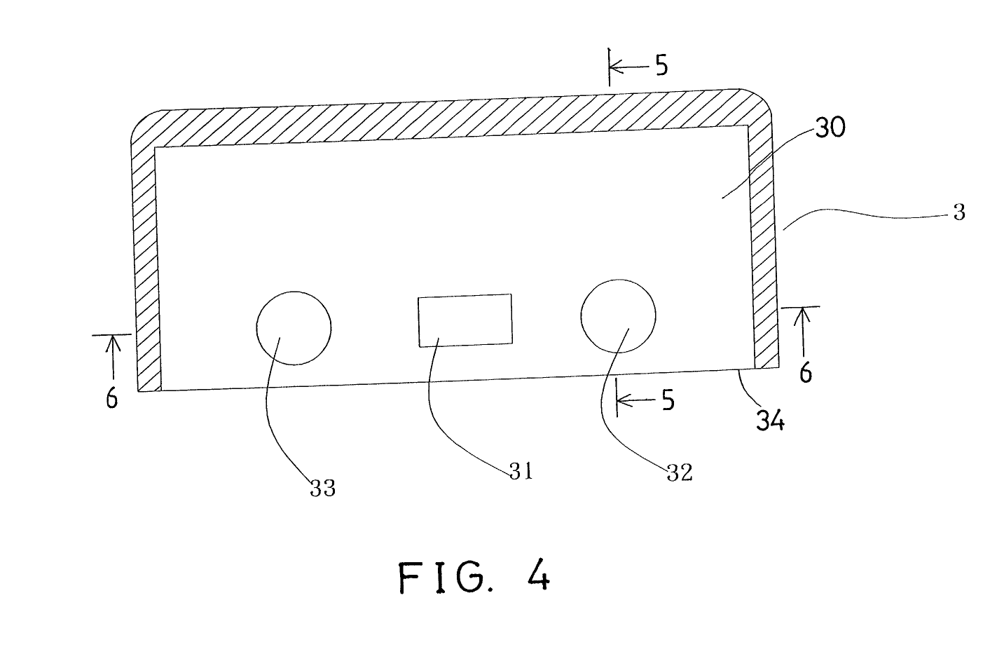

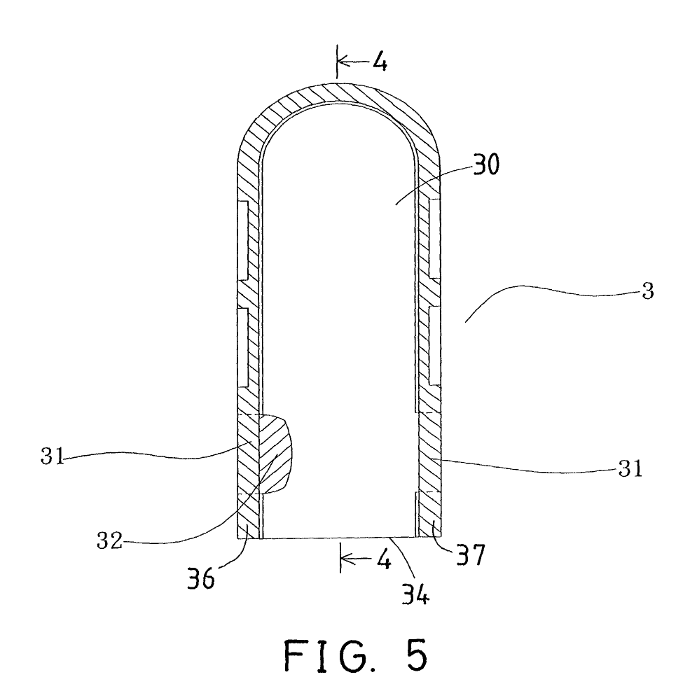

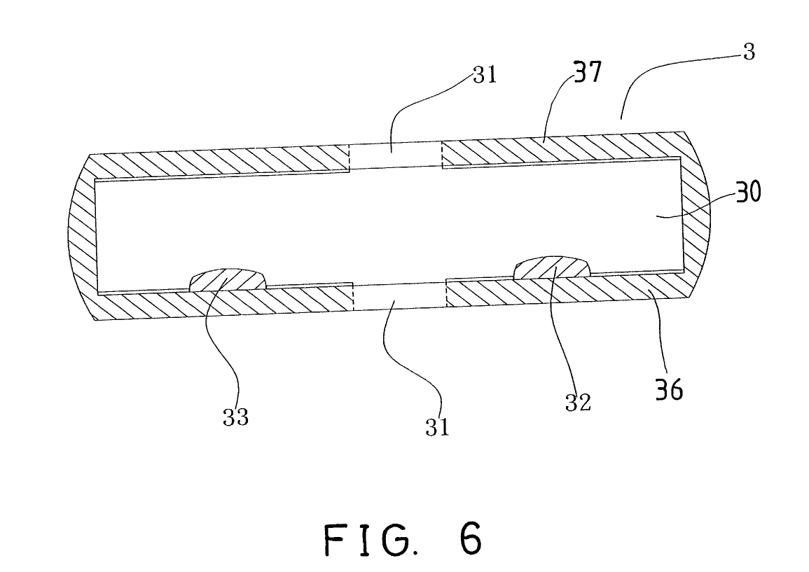

An indicator includes an indicator housing 3 having a chamber 30 formed therein, best shown in FIGS. 4-6, for receiving the flap 2, and having an open bottom 34 for allowing the flap 2 to be engaged into the chamber 30 of the indicator housing 3. The indicator housing 3 includes a front wall 36 and a rear wall 37 each having an aperture 31 formed in the middle portion thereof for receiving the middle spring latches 22 of the flap 2. The front wall 36 of the indicator housing 3 includes two or more bulges 32, 33 extended inward of the chamber 30 thereof and disposed or provided on the opposite sides of the aperture 31 thereof, for engaging into the respective orifices 23, 24 of the flap 2 (FIG. 3), and for solidly securing the indicator housing 3 onto the hanger hook 11 and for preventing the indicator housing 3 from becoming loose relative or from the hanger hook 11.

In operation, as shown in FIG. 1, the bulges 32, 33 of the indicator housing 3 may be engaged into the respective orifices 23, 24 of the flap 2, in addition to the engagement of the spring latch(es) 22 of the flap 22 into the aperture(s) 31 of the indicator housing, such that the indicator housing 3 may be solidly secured onto the hanger hook 11 and may be prevented from being rotated or moved or disengaged or from becoming loose relative or from the hanger hook

It is to be noted that the bulges 32, 33 of the indicator housing 3 and the orifices 23, 24 of the flap 2 are laterally spaced away from each other, and may be engaged with each other in addition to the engagement of the spring latch(es) 22 of the flap 22 into the aperture(s) 31 of the indicator housing, such that the indicator housing 3 may be solidly secured onto the hanger hook 11 without being becoming loose relative to the hanger hook 11.

Accordingly, the garment hanger in accordance with the present invention includes a solid indicator attachment.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A garment hanger comprising:
a hanger body including a hanger hook provided thereon, said hanger hook including a flap provided thereon, said flap including two sides each having at least one orifice formed therein, and
an indicator housing including a chamber formed therein and defined by a front wall and a rear wall, for receiving said flap, said front wall of said indicator housing including two sides each having at least one bulge extended inward of said chamber thereof for engaging into said at least one orifices of said flap and for solidly securing said indicator housing onto said flap.

2. A garment hanger comprising:
a hanger body including a hanger hook provided thereon, said hanger hook including a flap provided thereon, said flap including a middle portion having at least one latch provided therein and including two sides each having at least one orifice formed therein, and
an indicator housing including a chamber formed therein and defined by a front wall and a rear wall, for receiving said flap, said indicator housing including a middle portion having at least one aperture formed therein for receiving said at least one latch and for securing said indicator housing onto said flap, said front wall of said indicator housing including two sides each having at least one bulge extended inward of said chamber thereof for engaging into said at least one orifices of said flap and for solidly securing said indicator housing onto said flap.
